(19) United States
(12) Patent Application Publication
(10) Pub. No.: US 2026/0175178 A1
(43) Pub. Date: Jun. 25, 2026

(54) SPIRAL MEMBRANE ELEMENT AND MECHANICAL DEVICE FOR RECOVERING MEMBERS THEREOF

(71) Applicant: NITTO DENKO CORPORATION, Ibaraki-shi (JP)

(72) Inventors: Yasuhiro UDA, Ibaraki-shi (JP); Shinichi CHIKURA, Ibaraki-shi (JP); Maya KIHARA, Ibaraki-shi (JP); Seigo OGAWA, Ibaraki-shi (JP)

(21) Appl. No.: 19/423,766

(22) Filed: Dec. 17, 2025

(30) Foreign Application Priority Data
Dec. 24, 2024 (JP) 2024-227048

(51) Int. Cl. B01D 63/10; B01D 63/16; B01D 65/00

(52) U.S. Cl. CPC B01D 63/107; B01D 63/16; B01D 65/003

(57) ABSTRACT

A spiral membrane element includes: a plurality of membrane leaves each having a permeation-side spacer interposed between separation membranes facing each other and having both-side sealing parts and a peripheral-side sealing part that seal both-side ends and a peripheral-side end in an axial direction; a supply-side spacer interposed between the membrane leaves; and a perforated central pipe around which the membrane leaves and the supply-side spacers are wound. The permeation-side spacer in the membrane leaves has a tear processing part over the entire width on a peripheral side from the center.

### BACKGROUND OF THE INVENTION

### Field of the Invention

The present invention relates to a spiral membrane element capable of easily recovering members with relatively little contamination (for example, a permeation-side spacer and a central pipe) even after the contamination of members on a feed water side has progressed after long-term use, and a mechanical device suitable for the recovery operation of the spiral membrane element.

### Description of the Related Art

A typical structure of a spiral membrane element includes a plurality of membrane leaves each having a permeation-side spacer interposed between separation membranes facing each other and having both-side sealing parts and a peripheral-side sealing part that seal both-side ends and a peripheral-side end in an axial direction, a supply-side spacer interposed between the membrane leaves, and a perforated central pipe (also referred to as a "water collecting pipe") around which the membrane leaves and the supply-side spacers are wound. An adhesive is applied to three sides of both surfaces of the permeation-side spacer, and the separation membrane is fixed to each of both surfaces of the permeation-side spacer with an adhesive interposed therebetween.

Such a spiral membrane element deteriorates in performance over time as a result of deterioration over time and contamination of a separation membrane surface and the like due to its use. The performance of the separation membrane surface can be recovered to a certain extent by increasing a supply liquid-side flow rate according to flushing cleaning to physically wash contaminants on the separation membrane surface or chemically cleaning the separation membrane surface according to chemical cleaning. However, since the recovery is limited, the membrane element itself needs to be replaced.

A method for treating a used membrane element after replacement has a major problem, and landfill disposal has a problem because the volume of a treatable site is finite, and a membrane element most of which is a plastic material is not decomposed in the ground and thus semi-permanently remains in the ground. Therefore, it is desired to reduce waste caused by the used membrane element as much as possible. The same applies to a case where incineration disposal is performed.

Meanwhile, when the incineration disposal is performed, CO₂ which is a greenhouse gas is discharged, and thus there is a problem in terms of the global environment.

The membrane element is made of a plastic material derived from crude oil, which is a valuable fossil resource. The used element can also be said to be a valuable carbon resource. It is required to recycle the used element into the plastic material.

As techniques for reusing a used membrane element, for example, there are a structure in which an exterior member of a spiral membrane element can be reused (Patent Documents 1 to 2), a structure in which an anti-telescoping device can be reused (Patent Document 3), a structure in which a central pipe can be reused (Patent Document 4), and the like.

However, in any of these techniques, the structure of the spiral membrane element needs to be changed from the conventional structure, and the used spiral membrane element that has been used so far cannot be reused.

Meanwhile, Patent Document 5 proposes, as a method for reusing a used spiral membrane element having a conventional structure, a method in which a separation functional layer of an RO membrane element is removed with an acid aqueous solution or the like and reproduced into a UF membrane which is a porous support. However, in the reproducing method described in Patent Document 5, the used spiral membrane element cannot be reproduced as the same RO membrane element as that before reproduction, and thus the function of the original separation membrane cannot be restored.

### Prior Art Document

### Patent Document

Patent Document 1: JP-A-2000-15063

Patent Document 2: JP-A-2012-183527

Patent Document 3: JP-A-2008-149322

Patent Document 4: JP-A-11-267467

Patent Document 5: JP-A-11-156169

### SUMMARY OF THE INVENTION

A permeation-side constituent member is in contact with permeated water after filtration, and thus is a member that is relatively less contaminated even in the membrane element after use. That is, the permeation-side constituent member is suitable for recycling, but the member is inside the membrane leaf whose three sides are sealed with an adhesive resin, and thus it takes time and cost to take out the member. Therefore, a method and a structure capable of easily taking out the permeation-side spacer and the central pipe from the used membrane element are required.

Therefore, an object of the present invention is to provide a spiral membrane element that does not need to change the basic structure of the spiral membrane element to be reproduced, can reduce waste caused by the used spiral membrane element and save resources to be introduced, and can easily recover a permeation-side spacer and a central pipe, and a mechanical device suitable for the recovery operation.

The above object can be achieved by the present invention as described below.

(1) A spiral membrane element including: a plurality of membrane leaves each having two separation membranes facing each other, a permeation-side spacer provided therebetween, both-side sealing parts that seal both-side ends of the two separation membranes and the permeation-side spacer in an axial direction (A1), and a peripheral-side sealing part that seals a peripheral-side end parallel to the axial direction (A1) of the separation membranes and the permeation-side spacer; a supply-side spacer interposed between the membrane leaves adjacent to each other; and a perforated central pipe around which the membrane leaves and the supply-side spacers are wound,

wherein the permeation-side spacer in the membrane leaves has a tear processing part over the entire width (direction parallel to the central pipe) on a peripheral side from the center (at a position closer to the peripheral-side sealing part than to the central pipe).

[2] The spiral membrane element according to [1], wherein the tear processing part is a perforation processing part.

[3] The spiral membrane element according to [2], wherein the perforation processing part has a cut length of 10 mm to 100 mm and a cut interval of 0.5 mm to 3 mm.

[4] The spiral membrane element according to [1], wherein the tear processing part is a half cut processing part that does not penetrate through a thickness of the permeation-side spacer.

[5] The spiral membrane element according to [4], wherein the half cut processing part has a cut depth of 50% to 95% of the thickness of the permeation-side spacer.

[6] The spiral membrane element according to any one of [1] to [5], wherein a position of the tear processing part is 100 mm or less, 80 mm or less, 60 mm or less, or 50 mm or less from the peripheral-side sealing part toward the central pipe.

[7] The spiral membrane element according to any one of [1] to [6], wherein the central pipe has a structure in which both-end membrane bundle bonding parts and an intermediate water collecting part are connected by fitting.

[8] A method for decomposing a spiral membrane element according to any one of [1] to [7] and collecting a permeation-side spacer and a central pipe, the method including the steps of:

cutting a roll of the used spiral membrane element in a radial direction so as to remove both-side sealing parts or cutting off other members (permeation-side spacer, separation membrane, and supply-side spacers) with the central pipe left;

(optionally) removing both-end membrane bundle bonding parts from an intermediate water collecting part of the central pipe;

tearing a tear processing part by hooking and winding a peripheral sealing part (or separation membranes) of the membrane leaves after cut-off to separate the separation membranes and the supply-side spacers from the central pipe with the permeation-side spacer left.

[9] The method according to [8], further including the step of removing an exterior member (FRP) when the exterior member (FRP) is provided around the outer periphery of the used spiral membrane element.

(10) A mechanical device that recovers a permeation-side spacer and a central pipe from a spiral membrane element according to any one of [1] to [7],

the mechanical device including:

a main body shaft that rotatably suspends the central pipe of the spiral membrane element;

an eccentric shaft that hooks and winds peripheral-side sealing parts of membrane leaves from which both-side sealing parts have been removed; and

a rotation driving unit that rotates the eccentric shaft.

(11) The mechanical device according to [10], wherein the rotation driving unit has a manual, electric, pneumatic, or hydraulic driving force.

(1) According to the spiral membrane element of the present invention, the tear processing part is formed in the vicinity of the peripheral-side sealing part of the permeation-side spacer. Therefore, by pulling the peripheral-side sealing part of the membrane leaves from which both-side sealing parts have been removed in a direction away from the central pipe, the tear processing part is ruptured, the separation membranes (including the peripheral-side sealing part) and the supply-side spacers are easily separated from the central pipe with the permeation-side spacer left, and the permeation-side spacer and the central pipe can be collected.

(2) It is possible to minimize the contamination of the permeation-side spacer due to the dismantling operation, and thus, the permeation-side spacer is suitable for use as a raw material for material recycling or chemical recycling.

(3) If the central pipe has a structure in which the end membrane bundle bonding parts and the intermediate water collecting part are connected by fitting, both ends of the roll can be separated without cutting the central pipe when both ends of the roll are cut off. If it is not necessary to cut the central pipe together when cutting both ends of the roll, it is possible to insert a core rod into the central pipe when installing the roll in a cutting machine, which makes it possible to stably grip the membrane element.

(4) According to the mechanical device for recovering the permeation-side spacer and the central pipe from the spiral membrane element of the present invention, the peripheral-side sealing part of the membrane leaves from which the both-side sealing parts have been removed is hooked and wound in a direction away from the central pipe, so that the tear processing part is ruptured, the separation membranes and the supply-side spacers are easily separated from the central pipe with the permeation-side spacer left, and the permeation-side spacer and the central pipe can be recovered.

### BRIEF DESCRIPTION OF THE DRAWINGS

FIG. 1A is a partially exploded perspective view illustrating an example of a membrane element of the present invention;

FIG. 1B is a perspective view illustrating a main part obtained by cutting out a part of an example of the membrane element of the present invention;

FIG. 2A is a plan view illustrating an example of a step of cutting off both-side sealing parts;

FIG. 2B is a development view illustrating an example of a step of cutting off both-side sealing parts, which shows one of membrane leaves in a developed state;

FIG. 3A is a development view illustrating an example of a tear processing part, which shows one of membrane leaves in a developed state;

FIG. 3B is a schematic view illustrating an example of a perforation processing part as an example of the tear processing part;

FIG. 3C is a schematic view illustrating an example of a half cut processing part as an example of the tear processing part;

FIG. 4A -FIG. 4C are schematic views illustrating an example of a mechanical device that collects a permeation-side spacer and a central pipe;

FIG. 5A-FIG. 5C are schematic views illustrating an example of a division structure of the central pipe; and

FIG. 6 illustrates an example of a plan cross-sectional view of a membrane element.

### DETAILED DESCRIPTION OF THE PREFERRED EMBODIMENTS

### Spiral membrane element

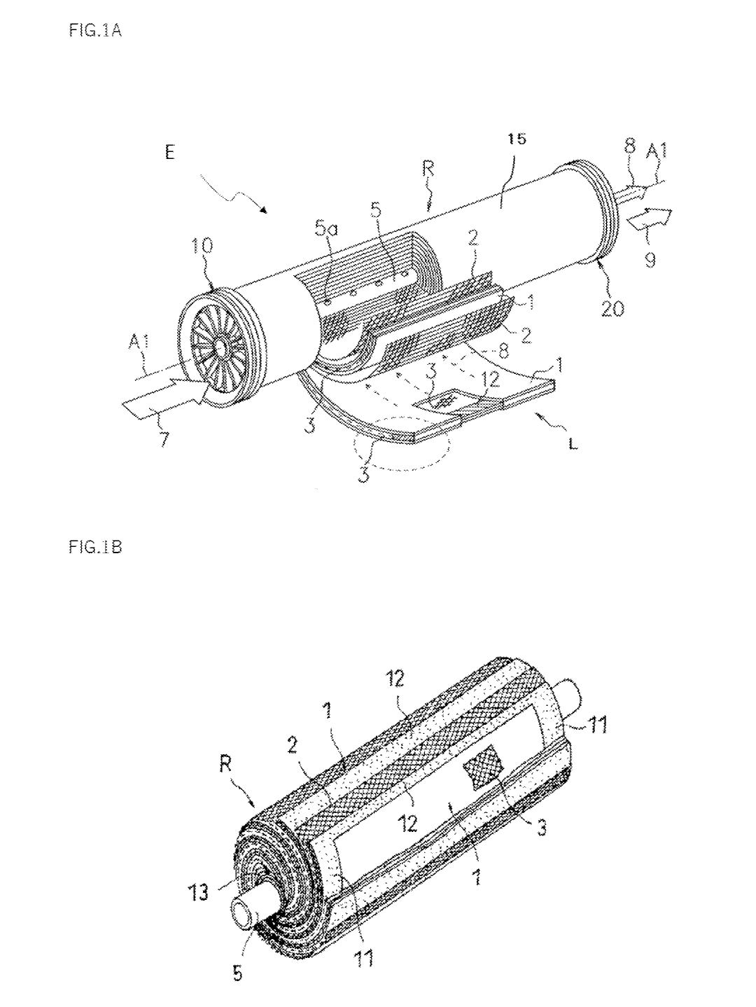

As illustrated in FIGS. 1A and 1B, a spiral membrane element E of the present invention (hereinafter, simply referred to as a "membrane element E") includes a plurality of membrane leaves L each having a permeation-side flow-channel between two separation membranes 1 facing each other, and a perforated central pipe 5 around which the membrane leaves L are wound with a supply-side flow-channel interposed between the membrane leaves L. Usually, the permeation-side flow-channel is formed by a permeation-side spacer 3, and the supply-side flow-channel is formed by a supply-side spacer 2. The membrane leaf L generally has a structure in which three sides of the two separation membranes 1 and the permeation-side spacer 3 are sealed with an adhesive.

Therefore, in the present embodiment, any known spiral membrane element can be used as long as the spiral membrane element includes the plurality of membrane leaves L each having the permeation-side spacer 3 interposed between the separation membranes 1 facing each other and having both-side sealing parts 11 and a peripheral-side sealing part 12 that seal both-side ends and a peripheral-side end in an axial direction A1, a supply-side spacer 2 interposed between the membrane leaves L, and the perforated central pipe 5 around which the membrane leaves L and the supply-side spacers 2 are wound. Both sides of an end of the permeation-side spacer 3 facing the peripheral-side sealing part 12 are directly fixed to the central pipe 5 with an adhesive.

In this specification, the membrane leaves L and the supply-side spacers 2 wound around the central pipe 5 are referred to as a roll R, and the membrane element E generally has a structure including an exterior member 15 around the outer periphery of the roll R as illustrated in FIG. 1A. The used membrane element is referred to as a used membrane element UE.

The membrane element E is provided with both-side sealing parts 11 and a peripheral-side sealing part 12 as sealing parts for preventing mixing of a supply-side flow-channel and a permeation-side flow-channel. As illustrated in FIG. 1B, the both-side sealing parts 11 among the sealing parts are obtained by using an adhesive to seal two side ends on both sides in the axial direction A1 of each of the membrane leaves L. The peripheral-side sealing part 12 is obtained by using an adhesive to seal ends of the peripheral-side tip of each of the membrane leaves L. An area surrounded by the two separation membranes 1 facing each other, the both-side sealing parts 11, and the peripheral-side sealing part 12 serves as the permeation-side flow-channel. This communicates with openings 5a of the central pipe 5.

As illustrated in FIG. 1B, in the present invention, the membrane element may include a central-side sealing part 13 obtained by using an adhesive to seal the perforated central pipe 5 and a base end of each of the membrane leaves L. In this example, the membrane element includes the roll R in which the membrane leaf L and the supply-side spacers 2 are wound around the central pipe 5 with such a central-side sealing part 13 interposed therebetween. The adhesive is not particularly limited, and any conventionally known adhesive such as a urethane-based adhesive or an epoxy-based adhesive can be used.

In the general membrane element E, as illustrated in FIG. 1A, an upstream-side end member 10 such as a seal carrier is provided on the upstream side of the roll R, and a downstream-side end member 20 such as an anti-telescoping device is provided on the downstream side. The upstream-side end member 10 and the downstream-side end member 20 may be integrated with the roll R by winding FRP serving as the exterior member 15 around the outer periphery of the roll R.

In a typical spiral membrane element having a diameter of 8 inches, about 15 to 30 sets of membrane leaves L are wound. When the membrane element E is used, the membrane element E is accommodated in a pressure vessel (vessel), and a supply liquid 7 is supplied from one end surface side of the membrane element E.

As illustrated in FIG. 1A, the supplied supply liquid 7 flows along the supply-side spacers 2 into a direction parallel with the axial direction A1 of the central pipe 5, and is then discharged as a concentrated liquid 9 from the other end surface side of the membrane element E. In the process in which the supply liquid 7 flows along the supply-side spacers 2, a permeation liquid 8 which has permeated through the separation membranes 1 flows along the permeation-side spacers 3, then flows into the central pipe 5 from the openings 5a, and is discharged from the end of the central pipe 5.

The supply-side spacer 2 generally has a function of ensuring spaces, the spaces being for uniformly supplying a fluid onto a membrane surface. The supply-side spacer 2 may be, for example, a net, a knitted fabric, or a sheet worked to have irregularities. Such a spacer that has a maximum thickness of about 0.1 to 3 mm can be appropriately used if necessary. The spacer is set on each of both surfaces of the separation membrane 1. Two different flow- channel members are generally used: one thereof is used, on the supply liquid side, as the supply-side spacer 2, and the other is used, on the permeation liquid side, as the permeation-side spacer 3. In the supply-side spacer 2, a thick network flow-channel member having large meshes is used, and in the permeation-side spacer 3, a woven fabric or knitted fabric flow-channel member having fine meshes is preferably used.

As illustrated in FIG. 1A, the central pipe 5 only needs to have a pipe wall having the openings 5a, and any conventional central pipe can be used. In general, in the case of use in seawater desalination, wastewater treatment or the like, permeated water that has permeated through the separation membrane 1 flows toward the central pipe 5 in the permeation-side flow-channel formed along the permeation-side spacer 3 interposed between the separation membranes 1 facing each other, then flows into the central pipe 5 from the openings 5a, flows in the central pipe 5, and is discharged from the end.

When an RO membrane or an NF membrane is used in applications such as seawater desalination and wastewater treatment, the permeation-side spacer 3 is interposed between the separation membranes 1 facing each other in the membrane leaves L as illustrated in FIG. 1A. The permeation-side spacer 3 is required to support the separation membranes 1 from the back sides of the membranes against pressure applied to the separation membranes 1, and further to ensure flow-channels for permeation liquid.

In order to ensure such a function, the permeation-side spacer 3 is preferably formed of a tricot knitted fabric, and more preferably a tricot knitted fabric subjected to resin impregnation reinforcement or fusion treatment after the formation of the knitted fabric. A warp knitting material such as tricot half knitting or double Denby knitting of a polyester material is used.

As the separation membrane 1, various porous membranes can be used, but a composite semipermeable membrane including a separation functional layer on the surface of a porous support is preferable. The porous support preferably includes a polymer porous layer on one surface of a nonwoven fabric layer.

Such a composite semipermeable membrane is called an RO (reverse osmosis) membrane, an NF (nano-filtration) membrane, or an FO (forward osmosis) membrane depending on the filtration properties or treatment methods, and is usable for the production of ultrapure water, seawater desalination, desalinization of brackish water, and reuse of wastewater and the like.

Examples of the exterior member 15 include various sheets, films, and tapes, and if necessary, a fiber reinforced resin (FRP) or the like is used for reinforcement. In a structure in which the upstream-side end member 10 and the downstream-side end member 20 are firmly integrated by the exterior FRP, it is difficult to disassemble and collect the upstream-side end member 10 and the downstream-side end member 20. However, by cutting off the both-side sealing parts 11 at the time of recycling, these members are easily separated and collected.

### Tear processing part of permeation-side spacer

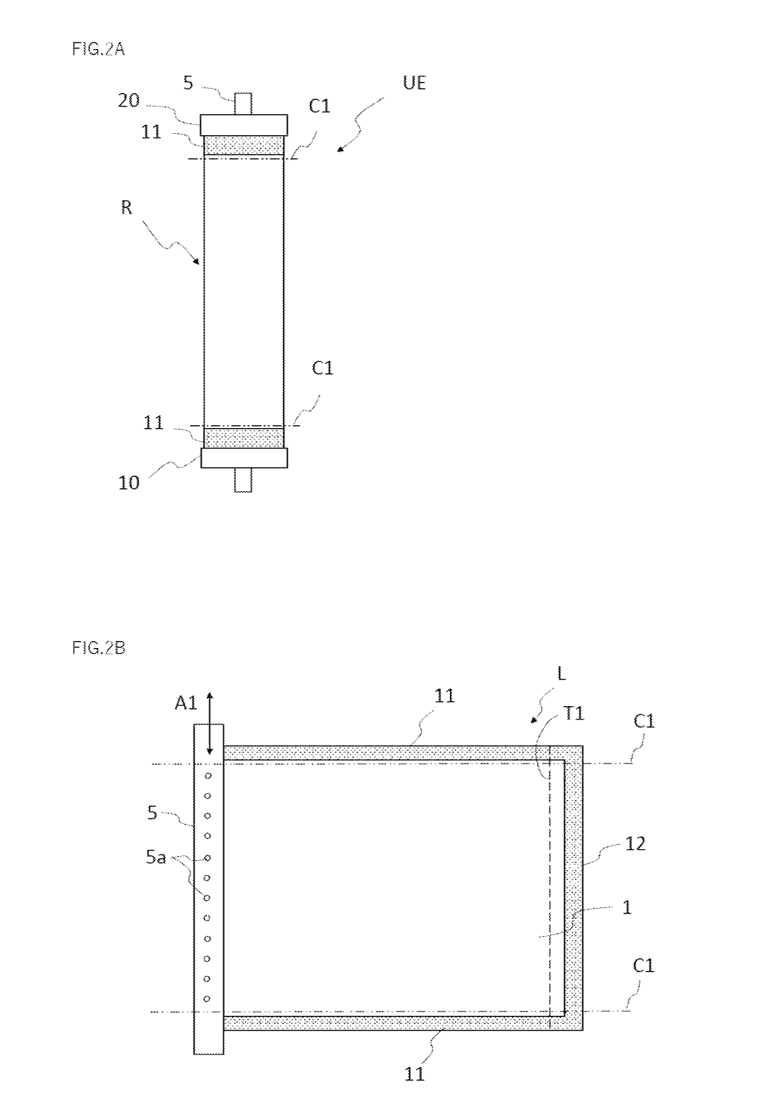

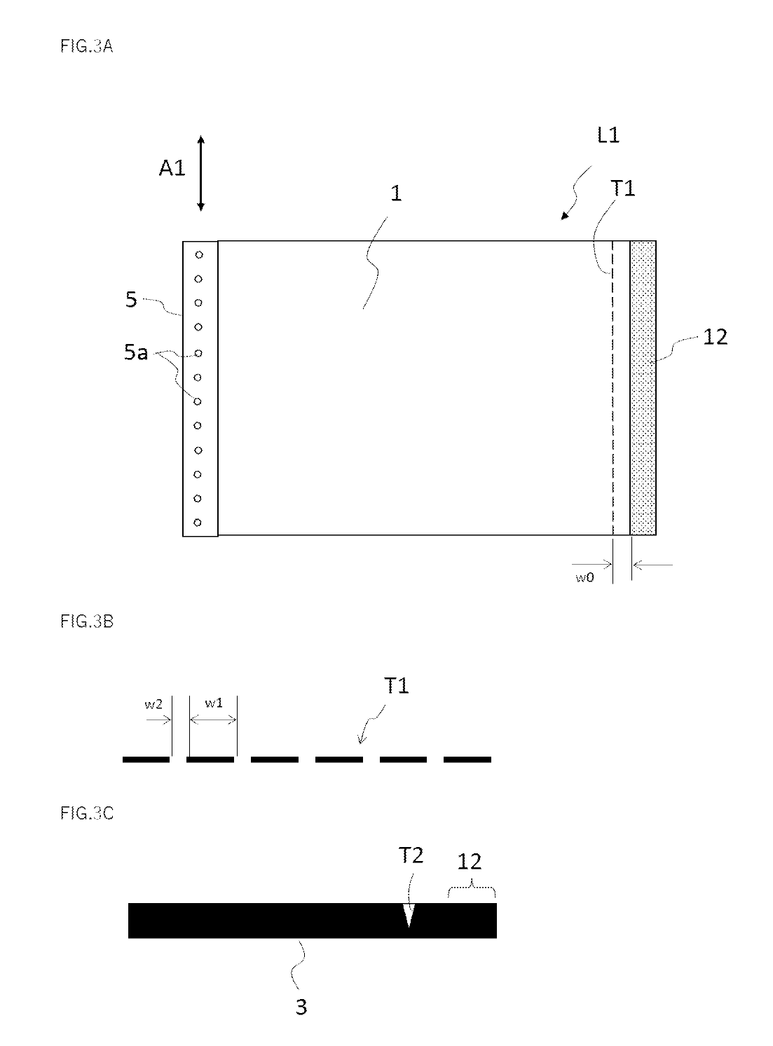

In the permeation-side spacer 3 in the membrane leaves L, a tear processing part T1 is formed over the entire width (direction of the central pipe 5) on a peripheral side from the center (at a position closer to the peripheral-side sealing part 12 than to the central pipe 5). In FIGS. 2B and 3A, a perforation processing part is indicated by a broken line as an example of the tear processing part T1. The perforation processing part illustrated in FIG. 3B has a cut length w1 of 10 mm to 100 mm and a cut interval w2 of 0.5 mm to 3 mm. When the cut length w1 is less than 10 mm or the interval w2 exceeds 3 mm, the tearability of the permeation-side spacer is deteriorated. When the cut length w1 exceeds 100 mm, the firmness and rigidity of the permeation-side spacer are lowered, which makes it difficult to handle the permeation-side spacer at the time of assembly. When the interval w2 is less than 0.5 mm, the permeation-side spacer may be ruptured at the time of assembly or use.

As illustrated in FIG. 3A, the position of the tear processing part T1 is set such that a distance w0 from the peripheral-side sealing part 12 toward the central pipe 5 is 10 mm to 100 mm, preferably 10 mm to 80 mm, more preferably 10 mm to 60 mm, and still more preferably 10 mm to 50 mm. When the distance w0 is less than 10 mm, the tear processing part T1 is too close to the peripheral-side sealing part 12, so that the tear processing part T1 may interfere with adhesive application processing. When the distance w0 exceeds 100 mm, the area of the reusable permeation-side spacer decreases.

### Another example of tear processing part

A tear processing part T2 in FIG. 3C is a half cut part. The half cut part has a cut depth of 50% to 95% of the thickness of the permeation-side spacer. When the cut depth is less than 50%, the tearability of the permeation-side spacer is deteriorated, and when the cut depth exceeds 95%, the permeation-side spacer may be ruptured during assembly or use. The position of the tear processing part T2 is the same as the distance w0 described above.

### Method for recovering reproduced member

A method for recovering a reproduced member is a method for disassembling the used membrane element UE and recovering the permeation-side spacer and the central pipe.

(S1) (S1) is a step of removing the exterior member 15 when the exterior member 15 is provided around the outer periphery of the used membrane element UE.

(S2) (S2) is a step of cutting the roll R of the used membrane element UE in a radial direction so as to remove the both-side sealing parts 11, or cutting off other members (permeation-side spacer 3, separation membranes 1, and supply-side spacers 2) with the central pipe 5 left.

(S3) (S3) is a step of (optionally) removing both-end membrane bundle bonding parts 600 from an intermediate water collecting part 610.

(S4) (S4) is a step of tearing the tear processing part T1 by hooking and winding the peripheral-side sealing part 12 or the separation membranes 1 of the membrane leaves L after cut-off, to separate the separation membranes 1 and the supply-side spacers 2 from the central pipe 5 with the permeation-side spacer 3 left.

### Step of cutting off both-side sealing parts: S2

FIG. 2A is a plan view illustrating an example of a step of cutting off the both-side sealing parts 11, and FIG. 2B is a development view illustrating an example of a step of cutting off the both-side sealing parts 11, which shows one of membrane leaves L in a developed state.

The both-side sealing parts 11 usually include the two separation membranes 1 facing each other and the permeation-side spacer 3 interposed therebetween and are fixed with an adhesive. In this step, as illustrated in FIG. 2A, it is preferable to cut off both-side ends of the supply-side spacer 2 in the axial direction A1 on the center side from the both-side sealing parts 11 when cutting off the both-side sealing parts 11.

As illustrated in FIG. 3A, the membrane leaf L1 is obtained in which the two separation membranes 1 facing each other and the permeation-side spacer 3 are bonded to each other only by the peripheral-side sealing part 12 among the sealing parts at the three side ends of the membrane leaf L. At this time, one or more membrane leaves L1 may be fixed (bonded or the like) to the central pipe 5 via the permeation-side spacer 3. Also, when both-side ends of the supply-side spacer 2 are cut off, the length of the supply-side spacer 2 in the axial direction A1 can be made equal to the length of the permeation-side spacer 3.

In this step, it is sufficient that at least the both-side sealing parts 11 are cut off from the main body of the used membrane element UE, and the end of the central pipe 5, the upstream-side end member 10, or the downstream-side end member 20 may be simultaneously removed. That is, it is also possible to leave the ends without cutting the central pipe 5. In the present embodiment, an example is shown in which the both-side sealing parts 11, the both-side ends of the central pipe 5, the upstream-side end member 10, and the downstream-side end member 20 are cut off.

Examples of the method for cutting off the both-side sealing parts 11 include a method for removing both ends of the roll R including the both-side sealing parts 11 and both ends of the central pipe 5 from the main body of the used membrane element UE by cutting at a cutting line C1, a method for separating both ends of the roll R including the both-side sealing parts 11 from the main body of the used membrane element UE by cutting only the roll R without cutting the central pipe 5, and the like. Simultaneously or separately from these methods, it is also possible to remove the upstream-side end member 10 and the downstream-side end member 20. A method for removing the entire both ends of the roll R including the both-side sealing parts 11 by cutting or the like may be used.

The width at the time of cutting off the both-side sealing parts 11 of the used membrane element UE is preferably 50 mm or less based on the length of the separation membrane 1 in the axial direction A1. In addition, it is preferable that the length of the separation membrane 1 after cut-off is 87% or more of the length before cut-off, based on the length of the separation membrane 1 before cut-off in the axial direction A1.

### Step of winding peripheral-side sealing part: S4

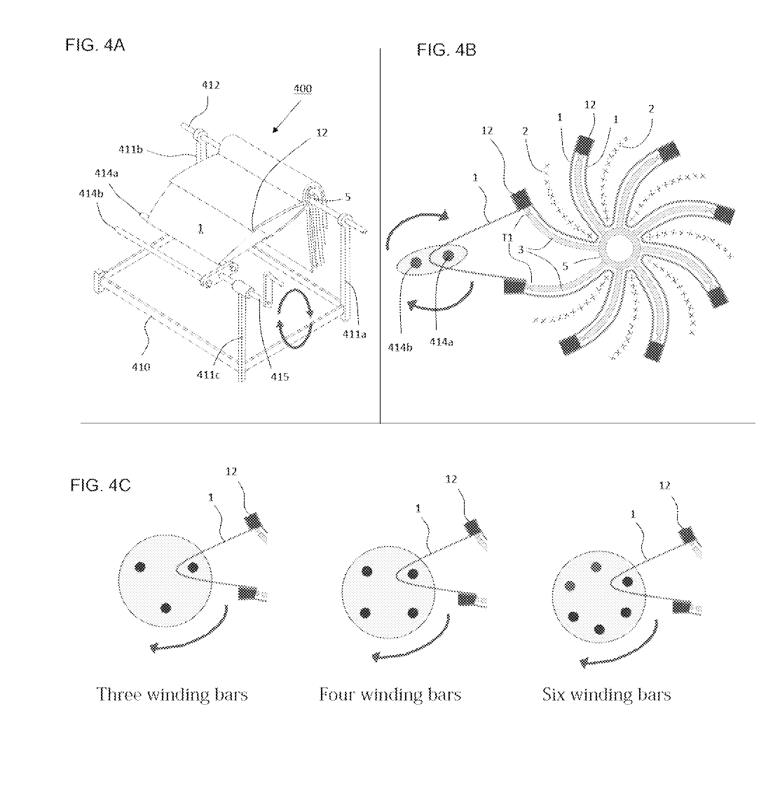

After the both-side sealing parts 11 are cut off, the separation membrane 1 or the peripheral-side sealing part 12 of any membrane leaf L is hooked and wound to tear the tear processing part T1, and the separation membrane 1 and the supply-side spacer 2 are separated from the central FIG. 4A-FIG. 4C illustrates example of a mechanical device 400 that collects a permeation-side spacer 3 and a central pipe 5 with the permeation-side spacer 3 left and a central pipe 5.

The mechanical device 400 includes a rectangular frame 410, a pair of supporting columns 411a and 411b perpendicularly extending from the frame 410, and a supporting column 411c perpendicularly extending from the frame 410 and disposed to face the pair of supporting columns 411a and 411b.

The mechanical device 400 includes a main body shaft 412 that rotatably suspends the central pipe 5 on the pair of supporting columns 411a and 411b, and an eccentric shaft 415 that hooks and winds the separation membrane 1 or the peripheral-side sealing part 12 of the membrane leaf L from which the both-side sealing parts 11 have been removed. The eccentric shaft 415 includes two or more winding bars 414a and 414b. The eccentric shaft 415 is rotatably attached to the supporting column 411c. The eccentric shaft 415 is configured to be rotatable manually or by a power source.

As an example of the power source, the eccentric shaft 415 may be connected to a rotation driving unit. The rotation driving unit may be configured by electric driving, pneumatic driving, or hydraulic driving.

As shown in FIGS. 4(a) and 4(b), the separation membrane 1 is suspended (hooked) on the rod-shaped winding bar 414a of the mechanical device 400. Next, when the eccentric shaft 415 is rotated, the tear processing part T1 is ruptured, and the separation membrane 1 and the supply-side spacer 2 connected by the peripheral-side sealing part 12 are wound around the winding bar 414a. Accordingly, the separation membrane 1 and the supply-side spacer 2 are separated from the central pipe 5 with the permeation-side spacer 3 left.

As another embodiment, FIG. 4C illustrates examples of three, four, and six winding bars.

When the separation membrane 1 is continuously collected using the mechanical device 400, the supply-side spacer 2 may fall by its own weight if the supply-side spacer 2 is merely sandwiched between the membrane leaves L. Since the falling supply-side spacers 2 are entangled, bulky, and difficult to handle, it is preferable to collect the supply-side spacers 2 at the same time as collecting the separation membrane 1. The fold portion of the separation membrane 1 on the central pipe 5 side is protected with a tape or the like in order to protect the separation layer, and the supply-side spacers 2 are further taped onto the protective tape. By this taping, the supply-side spacers 2 do not fall at the time of collecting the separation membrane 1, and the supply-side spacers 2 can also be efficiently collected.

### Separation

Collecting the separation membrane, the peripheral-side sealing part (ends of two separation membranes, end of permeation-side spacer, and composite part of sealing resin), and the supply-side spacer in a compact state as the roll by the mechanical device 400 is convenient when the collected members are delivered to a chemical recycling process by thermal decomposition. In order to deliver the collected members, it is preferable to separate the supply-side spacer suitable for thermal decomposition and other materials not suitable for thermal decomposition (separation membrane, permeation-side spacer, sealing resin) by pretreatment.

Examples of the pretreatment include a step of crushing the collected members and a step of separating the members by a difference in specific gravity using an aqueous solution. For example, since the specific gravity of the material of the supply-side spacer is light (for example, polypropylene resin: about 0.9, polyethylene resin: about 0.95) and the specific gravity of other material is heavy (for example, polyethylene terephthalate: about 1.6, fiber-reinforced plastic: about 1.8, and urethane resin: about 1.2), the members can be easily separated and collected by using an aqueous solution (specific gravity: about 1.05) whose specific gravity is adjusted after chopping. Furthermore, when centrifugal separation is performed by a fluid cyclone, the separation can be advanced quickly and efficiently.

### Another embodiment of step of cutting off both-side sealing parts

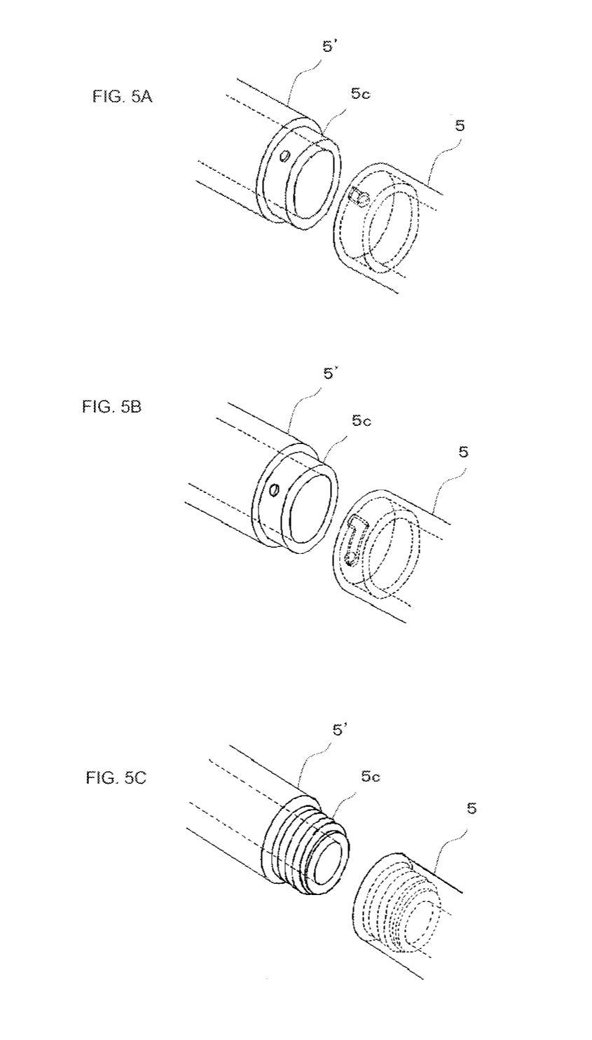

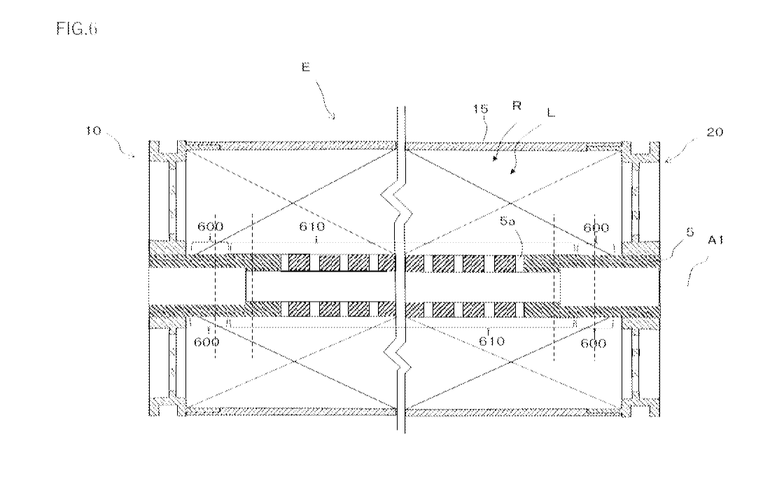

The central pipe 5 illustrated in FIGS. 5 and 6 has a structure that can be divided at both ends in a longitudinal direction. FIG. 6 illustrates a cross-section of a plane of the membrane element E. A broken line frame in FIG. 6 indicates a boundary between both-end membrane bundle bonding parts 600 and an intermediate water collecting part 610, and a fitting part in FIG. 5A-5C are provided here. By adopting a structure in which the both-end membrane bundle bonding parts 600 and the intermediate water collecting part 610 are connected by fitting, the both-side sealing parts 11 can also be divided at a cutting position. The fitting part does not require a seal, such as an adhesive. When the roll is wound up at the time of producing the membrane element, torque acts on the central pipe 5, so that the fitting part has a whirl-stop mechanism in the circumferential direction. Specifically, the fitting part can be configured by a latch mechanism that can be fastened only by pushing using the elasticity of the material of the central pipe, a mechanism in which a rotating operation is added to the latch mechanism, or screw fastening or the like.

FIGS. 5A to 5C illustrate examples of the fitting structure of the central pipe 5. In the example illustrated in FIG. 5A, a fitting connection part 5c of an end-side central pipe 5' has a protrusion, and the main body of the central pipe 5 has a guide groove and a recess. Therefore, the fitting connection part 5c can be pushed to lock the protrusion to the recess for fixing.

In the example illustrated in FIG. 5B, the fitting connection part 5c of the end-side central pipe 5' has a protrusion, and the main body of the central pipe 5 has an L-shaped guide groove and a recess. Therefore, when the fitting connection part 5c is pushed and rotated so that the protrusion follows the guide groove, the protrusion can be locked to the recess for fixing.

In the example illustrated in FIG. 5C, the fitting connection part 5c of the end-side central pipe 5' has a male screw structure and the main body of the central pipe 5 has a female screw structure. Therefore, the fitting connection part 5c can be rotated and screwed.

According to the present invention, the permeation-side spacer and the central pipe can be efficiently recovered from the used membrane element. It is possible to minimize the contamination of the permeation-side spacer due to the dismantling operation, and thus, the permeation-side spacer can be used as raw materials for material recycling or chemical recycling.

What is claimed is:

1. A spiral membrane element comprising:
a plurality of membrane leaves each having a permeation-side spacer interposed between separation membranes facing each other and having both-side sealing parts and a peripheral-side sealing part that seal both-side ends and a peripheral-side end in an axial direction;
a supply-side spacer interposed between the membrane leaves; and
a perforated central pipe around which the membrane leaves and the supply-side spacers are wound,
wherein the permeation-side spacer in the membrane leaves has a tear processing part over the entire width on a peripheral side from the center.

2. The spiral membrane element according to claim 1, wherein the tear processing part is a perforation processing part.

3. The spiral membrane element according to claim 2, wherein the perforation processing part has a cut length of 10 mm to 100 mm and a cut interval of 0.5 mm to 3 mm.

4. The spiral membrane element according to claim 1, wherein the tear processing part is a half cut processing part that does not penetrate through a thickness of the permeation-side spacer.

5. The spiral membrane element according to claim 4, wherein the half cut processing part has a cut depth of 50% to 95% of the thickness of the permeation-side spacer.

6. The spiral membrane element according to claim 1, wherein a position of the tear processing part is 50 mm or less from the peripheral-side sealing part toward the central pipe.

7. The spiral membrane element according to claim 1, wherein the central pipe has a structure in which both-end membrane bundle bonding parts and an intermediate water collecting part are connected by fitting.

8. A mechanical device that recovers a permeation-side spacer and a central pipe from a spiral membrane element according to claim 1,
the mechanical device comprising:
a main body shaft that rotatably suspends the central pipe of the spiral membrane element;
an eccentric shaft that hooks and winds peripheral-side sealing parts or separation membranes of membrane leaves from which both-side sealing parts have been removed; and
a rotation driving unit that rotates the eccentric shaft.

9. The mechanical device according to claim 8, wherein the rotation driving unit has a manual, electric, pneumatic, or hydraulic driving force.
